(19) United States
(12) Patent Application Publication
(10) Pub. No.: US 2025/0046497 A1
(43) Pub. Date: Feb. 6, 2025

(54) THERMAL RESISTOR AND MANUFACTURING METHOD THEREOF

(71) Applicant: YAGEO CORPORATION, Kaohsiung City (TW)

(72) Inventors: Shen-Li HSIAO, Kaohsiung City (TW); Kuang-Cheng LIN, Kaohsiung City (TW); Po-Hsun SHIH, Kaohsiung City (TW)

(21) Appl. No.: 18/519,088

(22) Filed: Nov. 27, 2023

(30) Foreign Application Priority Data
Aug. 4, 2023 (TW) 112129287

(51) Int. Cl. H01C 7/02; H01C 1/14; H01C 17/22; H01C 17/28

(52) U.S. Cl. CPC H01C 7/02; H01C 1/1406; H01C 17/22; H01C 17/28

(57) ABSTRACT

A thermal resistor includes a substrate, a thermistor, a front electrode, a passivation protection layer, and an external protection layer. The thermistor does not include an oxide and is made of a base metal. Therefore, it can reduce the production cost. The passivation protection layer is formed by sputtering, physical vapor deposition, or chemical vapor deposition, in which the passivation protection layer conformally covers a surface of the thermistor and can protect the underlying thermistor.

### RELATED APPLICATION

This application claims priority to Taiwan Application Serial Number 112129287, filed Aug. 4, 2023, which is herein incorporated by reference.

### BACKGROUND

### Field of Invention

The present disclosure relates to a thermal resistor and a manufacturing method thereof. More particularly, the present disclosure relates to a positive temperature coefficient (PTC) thermal resistor and a thermistor in the PTC thermal resistor is made of a base metal.

### Description of Related Art

In the field of thermal resistor, there are two main types: positive temperature coefficient (PTC) thermal resistors and negative temperature coefficient (NTC) thermal resistors. Platinum metals are used as thermistors for traditional platinum thermal resistors. However, platinum metal is scarce and expensive, so the production cost is high.

In addition, a temperature coefficient of resistance (TCR) of platinum metal is about 3800 ppm/° C. Platinum metal has a poor TCR compared to other metals having TCR above 4000 ppm/° C. Therefore, the temperature sensing of platinum metal is less precise than the temperature sensing of other metals.

For the foregoing reason, there is a need to solve the above-mentioned problems by providing a thermal resistor and a manufacturing method thereof.

### SUMMARY

The thermistor in the thermal resistor of the present disclosure is made of a base metal, such as pure nickel, pure titanium, or a titanium-tungsten alloy, etc. As a result, the production cost can be reduced. The thermistor(s) of the present disclosure have a higher temperature coefficient of resistance (TCR), which can provide a more sensitive and precise temperature response. In addition, the process of the thermistor(s) of the present disclosure is similar to that of the thin film resistor, so the thermistor(s) can be produced quickly and in mass production.

A thermal resistor is provided. The thermal resistor includes a substrate, a first thermistor, a first front electrode and a second front electrode, a passivation protection layer, and an external protection layer. The first thermistor is disposed on a first surface of the substrate, and the first thermistor does not include an oxide. The first thermistor has a first trimming groove. The first front electrode and the second front electrode are respectively disposed on two sides of the first thermistor, and contact the first thermistor. The passivation protection layer conformally covers the first thermistor. A thickness of the passivation protection layer is from 0.01 μm to 1 μm. The external protection layer covers the passivation protection layer.

In at least one embodiment of the present invention, a temperature coefficient of resistance (TCR) of the first thermistor is greater than 4000 ppm/° C.

In at least one embodiment of the present invention, the passivation protection layer covers the first front electrode with a width not greater than ⅓ of an entire width of the first front electrode.

In at least one embodiment of the present invention, the passivation protection layer covers the second front electrode with a width not greater than ⅓ of an entire width of the second front electrode.

In at least one embodiment of the present invention, a material of the first thermistor is pure nickel, pure titanium, or a titanium-tungsten alloy.

In at least one embodiment of the present invention, the thermal resistor further includes a pair of external electrodes. The pair of external electrodes is respectively disposed on the first front electrode and the second front electrode, and respectively covers one sidewall of the first front electrode and one sidewall of the second front electrode, and respectively covers opposite sidewalls of the first thermistor.

In at least one embodiment of the present invention, the thermal resistor further includes a pair of back electrodes. The pair of back electrodes is disposed on a second surface opposite to the first surface of the substrate. The pair of external electrodes further respectively covers opposite sidewalls of the substrate and the pair of back electrodes.

In at least one embodiment of the present invention, the thermal resistor further includes a second thermistor and a third front electrode. The second thermistor is disposed on the first surface of the substrate. The first thermistor is spaced apart from the second thermistor. The second front electrode contacts the substrate and the second thermistor. The second thermistor does not include an oxide. The second thermistor has a second trimming groove. The third front electrode is disposed on one side of the second thermistor and contacts the second thermistor. The passivation protection layer further conformally covers the second thermistor, and the external protection layer covers the second front electrode and the passivation protection layer.

In at least one embodiment of the present invention, a material of the first thermistor is pure nickel, pure titanium, or a titanium-tungsten alloy. A material of the second thermistor is pure nickel, pure titanium, or a titanium-tungsten alloy.

In at least one embodiment of the present invention, the thermal resistor further includes a pair of external electrodes. The pair of external electrodes is respectively disposed on the first front electrode and the third front electrode, and respectively covers one sidewall of the first front electrode and one sidewall of the third front electrode, and respectively covers opposite sidewalls of the first thermistor.

In at least one embodiment of the present invention, the thermal resistor further includes a pair of back electrodes. The pair of back electrodes is disposed on a second surface opposite to the first surface of the substrate. The pair of external electrodes further respectively covers opposite sidewalls of the substrate and the pair of back electrodes.

The present disclosure provides a manufacturing method of a thermal resistor including the following operations: forming a thermistor layer on a first surface of a substrate; forming an electrode layer on the thermistor layer, in which the electrode layer covers at least a portion of the thermistor layer; performing a trimming operation; conformally forming a passivation protection layer on the thermistor layer, in which the passivation protection layer completely covers the thermistor layer; forming an external protection layer to cover the passivation protection layer and a portion of the electrode layer; and forming a pair of external electrodes by electroplating, in which the pair of external electrodes cover a remaining portion of the electrode layer.

In at least one embodiment of the present invention, the manufacturing method of the thermal resistor further includes the following operation: forming a pair of back electrodes on a second surface opposite to the first surface of the substrate; and respectively forming a pair of side electrodes on opposite sidewalls of the substrate, in which the pair of external electrodes covers the pair of back electrodes and the pair of side electrodes.

In at least one embodiment of the present invention, the operation of forming the thermistor layer includes: forming a first thermistor and a second thermistor, in which the first thermistor is spaced apart from the second thermistor. The operation of forming the electrode layer on the thermistor layer includes: forming a first front electrode on one side of the first thermistor and contacting the first thermistor; forming a second front electrode on one side of the second thermistor and contacting the second thermistor; and forming a third front electrode to cover another side of the first thermistor and another side of the second thermistor, in which the third front electrode contacts the substrate.

In at least one embodiment of the present invention, the trimming operation further includes: performing a first trimming process on the first thermistor by using an etching method to form a first trimming groove; and performing a second trimming process on the second thermistor by using a laser method to form a second trimming groove.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1A, FIG. 2A, and FIG. 3A depict cross-sectional views of a thermal resistor at various process stages according to one embodiment of the present disclosure.

FIG. 1B, FIG. 2B, and FIG. 3B respectively depict top views of FIG. 1A, FIG. 2B, and FIG. 3A.

FIG. 4 depicts a cross-sectional view of a thermal resistor according to another embodiment of the present disclosure.

FIG. 5A, FIG. 6, and FIG. 7 depict cross-sectional views of a thermal resistor at various process stages according to still another embodiment of the present disclosure.

FIG. 5B depicts a top view of FIG. 5A.

FIG. 8 depicts a cross-sectional view of a thermal resistor according to yet another embodiment of the present disclosure.

### DESCRIPTION OF THE EMBODIMENTS

The following disclosure provides many different embodiments, or examples, for implementing different features of the present disclosure. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The device may be otherwise oriented (rotated 90 degrees or at other orientations) and the spatially relative descriptors used herein may likewise be interpreted accordingly.

It will be understood that, in the description herein and throughout the claims that follow, although the terms “first,” “second,” etc. may be used to describe various elements, these elements should not be limited by these terms. These terms are only used to distinguish one element from another. For example, a first element could be termed a second element, and, similarly, a second element could be termed a first element, without departing from the scope of the embodiments. It will be understood that, in the description herein and throughout the claims that follow, the term “and/or” includes any and all combinations of one or more of the associated listed items.

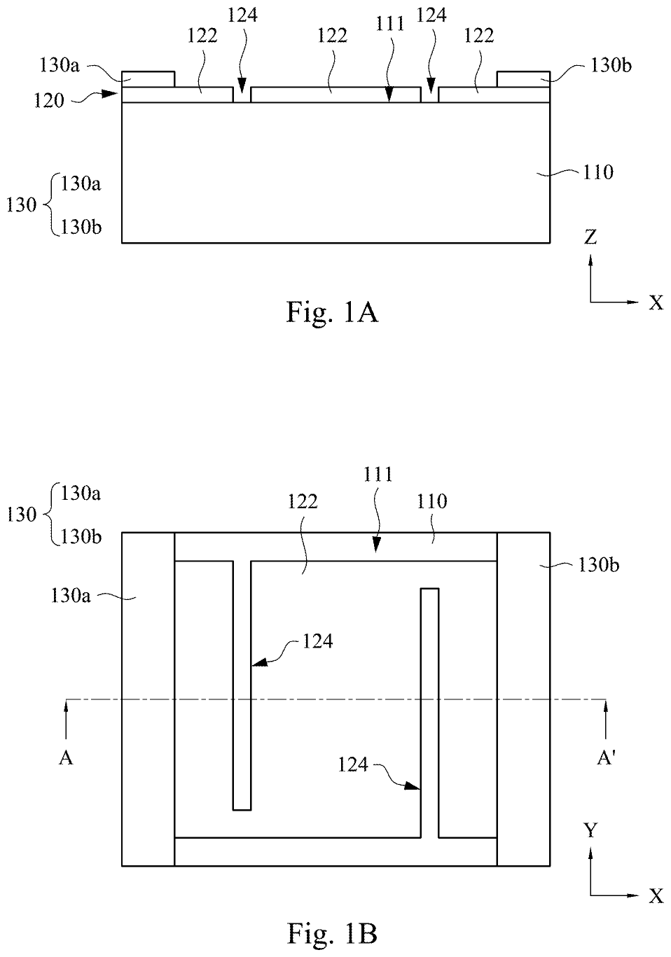

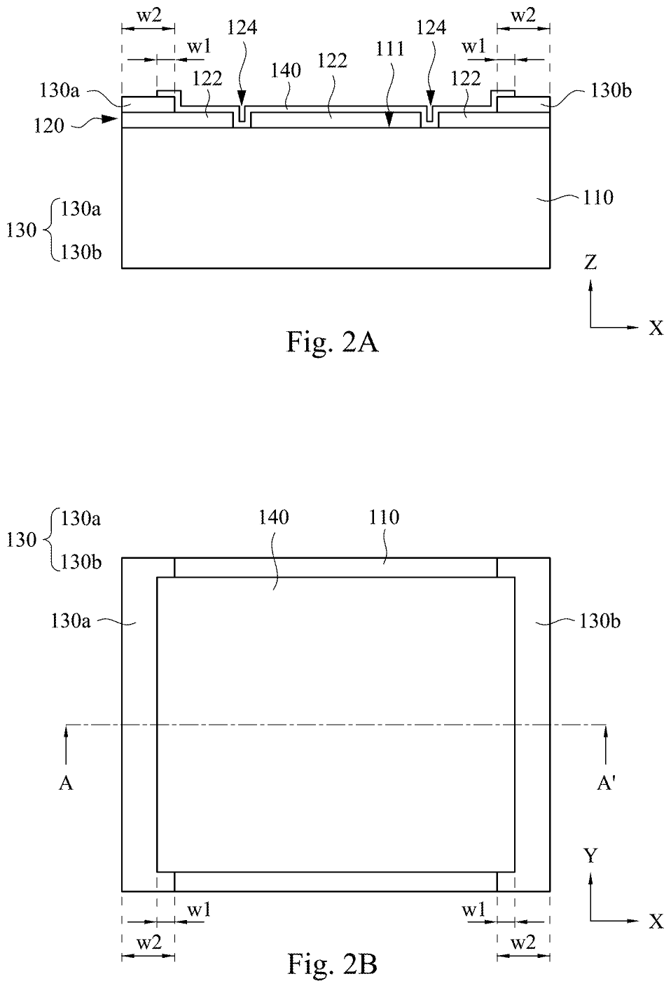

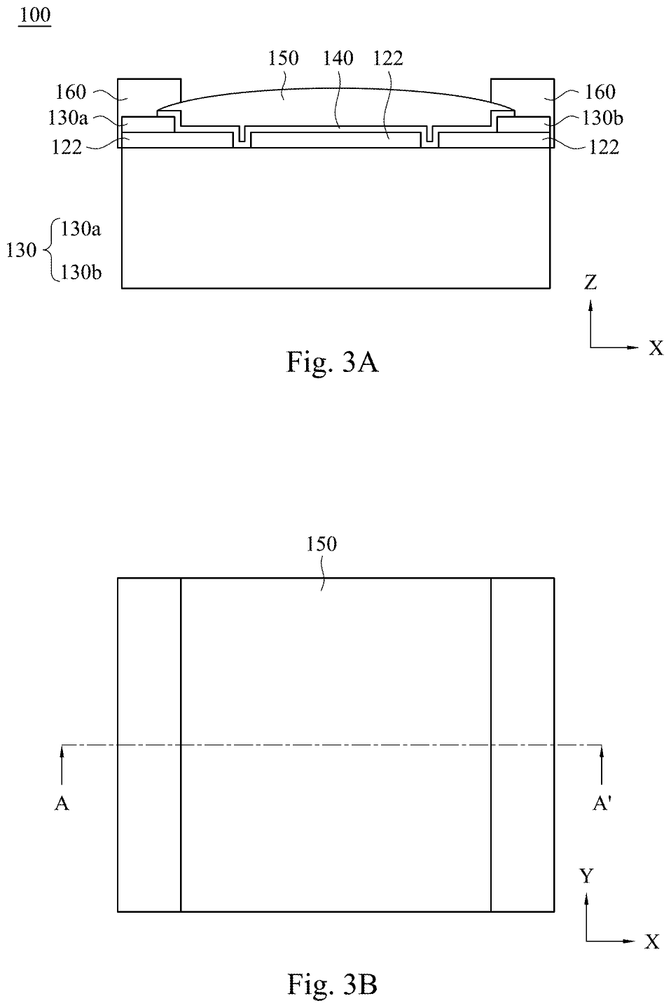

FIG. 1A, FIG. 2A, and FIG. 3A depict cross-sectional views of a thermal resistor 100 at various process stages according to one embodiment of the present disclosure. FIG. 1B, FIG. 2B, and FIG. 3B respectively depict top views of FIG. 1A, FIG. 2B, and FIG. 3A. Specifically, FIG. 1A, FIG. 2A, and FIG. 3A are cross-sectional views taken along a section line A-A′ in FIG. 1B, FIG. 2B, and FIG. 3B, respectively. A manufacturing method of the thermal resistor 100 is provided in detail as follows.

Reference is made to FIG. 1A. A substrate 110 is provided. A thermistor layer 120 is formed on a first surface 111 of the substrate 110. The thermistor layer 120 includes a thermistor 122. Reference is made to FIG. 1B. The thermistor 122 extends along a plane in the X direction and the Y direction. As shown in FIG. 1A, an electrode layer 130 is formed on two sides of the thermistor layer 120. The electrode layer 130 includes a first front electrode 130a and a second front electrode 130b. Reference is made to FIG. 1B. Both the first front electrode 130a and the second front electrode 130b extend along the Y direction.

Since the thermistor layer 120 has undergone a trimming operation, the thermistor 122 has a plurality of trimming grooves 124. In some embodiments, the thermistor 122 is first formed on the substrate 110, and then the electrode layer 130 is formed on the two sides of the thermistor 122. Next, the trimming operation is performed to form the plurality of trimming grooves 124. Each of the trimming grooves 124 exposes the first surface 111 of the substrate 110. In some embodiments, each of the trimming grooves 124 does not expose the first surface 111 of the substrate 110. It can be understood that a depth, a shape, and a number of the trimming grooves 124 may be adjusted depending on the resistance requirements, and are not limited to the trimming grooves 124 depicted in FIG. 1A and FIG. 1B. In some embodiments, the trimming grooves 124 are formed by etching. It is worth noting that the thermistor 122 is trimmed by using a non-thermal processing method. Therefore, the properties of the thin film may be better, and there is no problem of TCR caused by the thermal stress that affects the thin film.

It should be noted that the thermistor 122 in FIG. 1A is depicted as three separate thermistors. However, it can be understood that the three separate thermistors are in fact the connected thermistor 122, as shown in FIG. 1B.

In some embodiments, the substrate 110 may be a glass substrate or a ceramic substrate. In some embodiments, a material of the substrate 110 includes aluminum oxide (Al₂O₃) or aluminum nitride (AlN).

In some embodiments, the thermistor 122 is formed by printing, sputtering, or electroplating. In some embodiments, a thickness of the thermistor 122 is from 0.01 μm to 1 μm, such as 0.03 μm, 0.05 μm, or 0.08 μm. In some embodiments, a material of the thermistor 122 does not include an oxide. In some embodiments, the material of the thermistor 122 is pure nickel, pure titanium, or a titanium-tungsten alloy. In some embodiments, a temperature coefficient of resistance (TCR) of the thermistor 122 is greater than 4000 ppm/° C. In some embodiments, the material of thermistor 122 does not include copper. In some embodiments, a material of each of the first front electrode 130a and the second front electrode 130b includes silver and/or copper.

Reference is made to FIG. 2A. A passivation protection layer 140 is conformally formed on the thermistor layer 120. The passivation protection layer 140 is formed on an upper surface of the thermistor 122 and sidewalls and bottom surfaces of the trimming grooves 124. As shown in FIG. 2B, the passivation protection layer 140 completely covers the thermistor layer 120. As shown in FIG. 2A and FIG. 2B, the passivation protection layer 140 further covers a portion of the first front electrode 130a and a portion of the second front electrode 130b. In some embodiments, a width w1 of the first front electrode 130a and/or the second front electrode 130b covered by the passivation protection layer 140 is less than or equal to ⅓ of an overall width w2 of the first front electrode 130a and/or the second front electrode 130b. In other words, at least ⅔ of the overall width w2 of the first front electrode 130a and/or the second front electrode 130b are exposed.

In some embodiments, the passivation protection layer 140 is formed by sputtering, physical vapor deposition, or chemical vapor deposition. In some embodiments, a thickness of the passivation protection layer 140 is from 0.01 μm to 1 μm, such as 0.03 μm, 0.05 μm, or 0.08 μm. A material of the passivation protection layer 140 is tantalum oxide (Ta₂O₅) or silicon nitride (Si₃N₄). The passivation protection layer 140 is a fine and uniform protection layer that can avoid oxidation of the underlying thermistor 122. When the thickness of the passivation protection layer 140 is smaller than 0.01 μm, the underlying thermistor 122 may not be effectively protected. When the thickness of the passivation protection layer 140 is greater than 1 μm, an overall thickness of the thermal resistor may not be reduced. In some embodiments, the passivation protection layer 140 does not include a glass material.

Reference is made to FIG. 3A. An external protection layer 150 covers the passivation protection layer 140 and a portion of the electrode layer 130, and a pair of external electrodes 160 is electroplated to form the flip-chip thermal resistor 100. The pair of external electrodes 160 covers a remaining portion of the electrode layer 130. As shown in FIG. 3A, the external electrodes 160 further cover a portion of the external protection layer 150. The external electrodes 160 also cover a sidewall of the first front electrode 130a, a sidewall of the second front electrode 130b, and sidewalls of the thermistor 122.

In some embodiments, the external protection layer 150 is formed by printing. In some embodiments, a material of the external protection layer 150 includes an insulating material, such as epoxy resin and so on. In some embodiments, a material of each of the external electrodes 160 includes copper, tin, nickel, or combinations thereof.

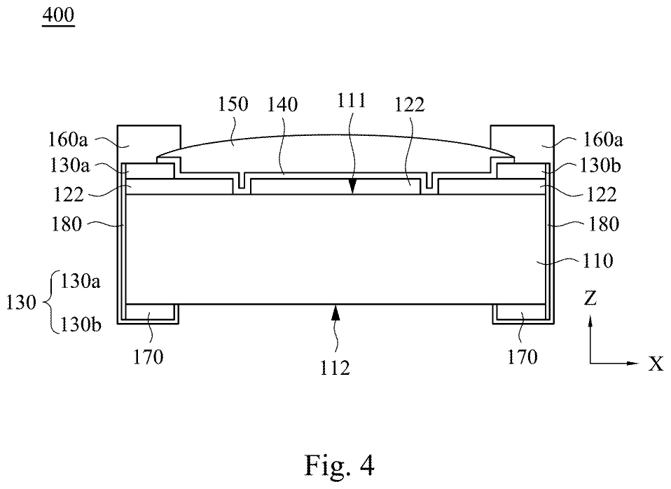

Reference is made to FIG. 4. FIG. 4 depicts a cross-sectional view of a thermal resistor 400 according to another embodiment of the present disclosure. The differences between the thermal resistor 400 of FIG. 4 and the thermal resistor 100 of FIG. 3A are that the thermal resistor 400 further includes external electrodes 160a, back electrodes 170, and side electrodes 180. The external electrodes 160a cover the back electrodes 170 and the side electrodes 180.

As shown in FIG. 4, the pair of back electrodes 170 are first formed on a second surface 112 opposite to the first surface 111 of the substrate 110, and then the pair of side electrodes 180 is respectively formed on opposite sidewalls of the substrate 110. Next, the external electrodes 160a is formed to cover the pair of back electrodes 170 and the pair of side electrodes 180.

In the embodiment shown in FIG. 4, the back electrodes 170 are disposed relative to the first front electrode 130a and the second front electrode 130b. In other words, the back electrodes 170 are disposed opposite to the first front electrode 130a and the second front electrode 130b. In some embodiments, the back electrodes 170 are formed by printing. In some embodiments, a material of each of the back electrodes 170 includes a silver paste having epoxy resin and silver.

In some embodiments, the side electrodes 180 are formed on the sidewalls of the first front electrode 130a and the second front electrode 130b, the sidewalls of the thermistor 122, and sidewalls of the back electrodes 170 by sputtering, so as to electrically conduct the first front electrode 130a to the back electrode 170 and electrically conduct the second front electrode 130b to the back electrode 170, as shown in FIG. 4. In some embodiments, a material of each of the side electrodes 180 is a nickel-chromium alloy.

In some embodiments, the external electrodes 160a may be formed by electroplating. Additionally, since a material of each of the external electrodes 160a is similar to or the same as the material of the above external electrodes 160, rather than elaborating on it. The thermal resistor 400 is a surface mount device (SMD).

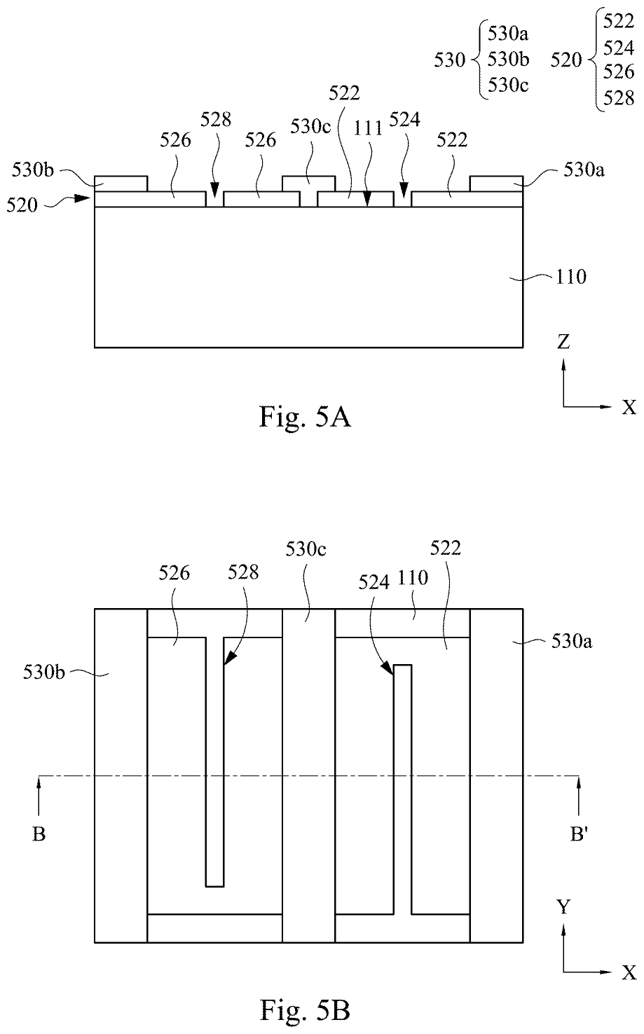

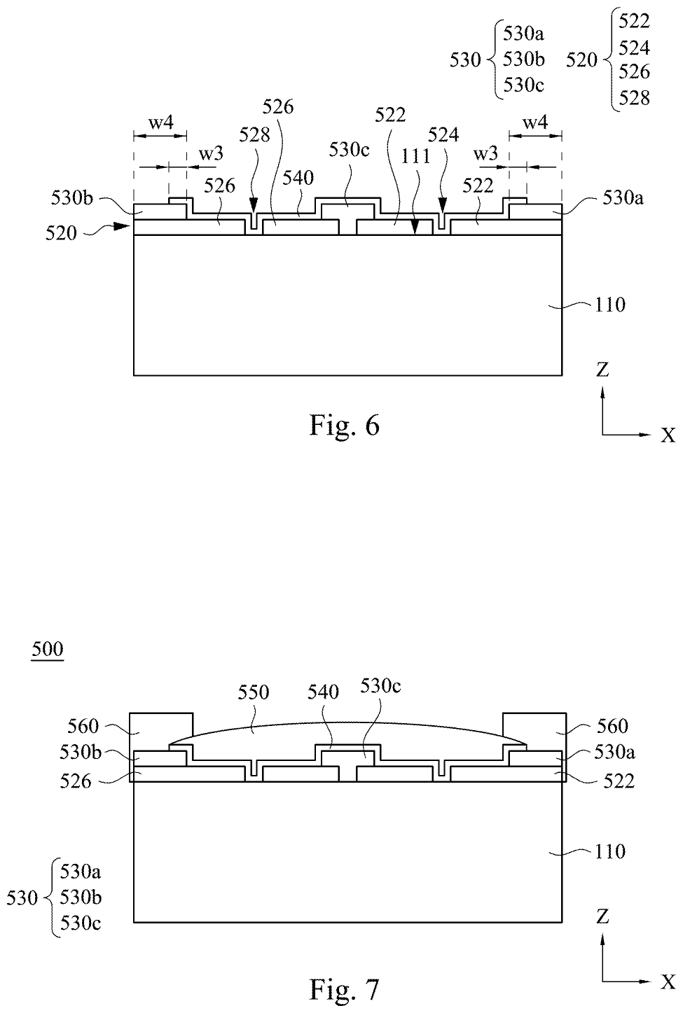

FIG. 5A, FIG. 6, and FIG. 7 depict cross-sectional views of a thermal resistor 500 at various process stages according to still another embodiment of the present disclosure. FIG. 5B depicts a top view of FIG. 5A. Specifically, FIG. 5A is a cross-sectional view taken along a section line B-B′ in FIG. 5B. A manufacturing method of the thermal resistor 500 is provided in detail as follows.

Reference is made to FIG. 5A and FIG. 5B. A thermistor layer 520 is formed on the first surface 111 of the substrate 110. The thermistor layer 520 includes a first thermistor 522 and a second thermistor 526. The first thermistor 522 is spaced apart from the second thermistor 526. Both the first thermistor 522 and the second thermistor 526 extend along a plane in the X direction and the Y direction.

As shown in FIG. 5A, an electrode layer 530 is formed on the thermistor layer 520. The electrode layer 530 includes a first front electrode 530a, a second front electrode 530b, and a third front electrode 530c. Reference is made to FIG. 5B. All of the first front electrode 530a, the second front electrode 530b, and the third front electrode 530c extend along the Y direction. The first front electrode 530a is formed on one side of the first thermistor 522 and contacts the first thermistor 522. The second front electrode 530b is formed on one side of the second thermistor 526 and contacts the second thermistor 526. The third front electrode 530c covers another side of the first thermistor 522 and another side of the second thermistor 526. The third front electrode 530c further contacts the first surface 111 of the substrate 110.

Since the thermistor layer 520 has undergone a trimming operation, the first thermistor 522 has a trimming groove 524, and the second thermistor 526 has a trimming groove 528. In some embodiments, the first thermistor 522 and the second thermistor 526 are first formed on the substrate 110, and then the electrode layer 530 is formed. Next, the trimming operation is performed to form the plurality of trimming grooves 524 and 528. Each of the trimming grooves 524 and 528 exposes the first surface 111 of the substrate 110. In some embodiments, the trimming groove 524 and/or the trimming groove 528 do not expose the first surface 111 of the substrate 110. It can be understood that depths, shapes, and numbers of the trimming grooves 524 and 528 can be adjusted depending on the resistance requirements, and are not limited to the trimming grooves 524 and 528 depicted in FIG. 5A and FIG. 5B.

In some embodiments, since the forming method and material properties of the first thermistor 522 are similar to or the same as the forming method and material properties of the thermistor 122, rather than elaborating on it. A material of the first thermistor 522 is pure nickel, pure titanium, or a titanium-tungsten alloy. The trimming groove 524 is formed by etching, and the first thermistor 522 is the resistance area of the main thermistor. It is worth noting that the first thermistor 522 is trimmed by using a non-thermal processing method. Therefore, the properties of the thin film can be better, and there is no problem of temperature coefficient of resistance (TCR) caused by the thermal stress that affects the thin film. In some embodiments, the forming method of the second thermistor 526 is similar to or the same as the forming method of the thermistor 122. In some embodiments, the second thermistor 526 does not include an oxide. In some embodiments, a material of the second thermistor 526 is a nickel-chromium alloy or a titanium-tungsten alloy. The trimming groove 528 is formed by laser cutting for refining its resistance value. The trimming method of the second thermistor 526 can trim the resistance value more precisely. In some embodiments, a thickness of first thermistor 522 is similar to or the same as a thickness of the second thermistor 526. In some embodiments, the thickness of first thermistor 522 and/or the thickness of the second thermistor 526 are from 0.01 μm to 1 μm, such as 0.03 μm, 0.05 μm, or 0.08 μm.

Reference is made to FIG. 6. A passivation protection layer 540 is conformally formed on the thermistor layer 520. The passivation protection layer 540 completely covers the thermistor layer 520. In the embodiment of FIG. 6, the passivation protection layer 540 further covers the third front electrode 530c. The passivation protection layer 540 is formed on an upper surface of the first thermistor 522 and sidewalls and a bottom surface of the trimming groove 524, and on an upper surface of the second thermistor 526 and sidewalls and a bottom surface of the trimming groove 528.

As shown in FIG. 6, the passivation protection layer 540 further covers a portion of the first front electrode 530a and a portion of the second front electrode 530b. In some embodiments, a width w3 of the first front electrode 530a and/or the second front electrode 530b covered by the passivation protection layer 540 is less than or equal to ⅓ of an overall width w4 of the first front electrode 530a and/or the second front electrode 530b. In other words, at least ⅔ of the overall width w4 of the first front electrode 530a and/or the second front electrode 530b are exposed.

In some embodiments, since the forming method and material properties of the passivation protection layer 540 are similar to or the same as the forming method and material properties of the passivation protection layer 140, rather than elaborating on it. In some embodiments, a thickness of the passivation protection layer 540 is from 0.01 μm to 1 μm, such as 0.03 μm, 0.05 μm, or 0.08 μm. When the thickness of the passivation protection layer 540 is smaller than 0.01 μm, the underlying thermistors 522 and 526 may not be effectively protected. When the thickness of the passivation protection layer 540 is greater than 1 μm, an overall thickness of the thermal resistor may not be reduced.

Reference is made to FIG. 7. An external protection layer 550 covers the passivation protection layer 540, a portion of the first front electrode 530a, a portion of the second front electrode 530b, and the third front electrode 530c, and a pair of external electrodes 560 is electroplated to form the flip-chip thermal resistor 500. The pair of external electrodes 560 covers a remaining portion of the first front electrode 530a and a remaining portion of the second front electrode 530b. As shown in FIG. 7, the external electrodes 560 further cover a portion of the external protection layer 550. The external electrodes 560 also cover one sidewall of the first front electrode 530a, one sidewall of the second front electrode 530b, one sidewall of the first thermistor 522, and one sidewall of the second thermistor 526.

In some embodiments, since the forming method and material properties of the external protection layer 550 are similar to or the same as the forming method and material properties of the external protection layer 150, rather than elaborating on it. In some embodiments, since the forming method and material properties of the external electrodes 560 are similar to or the same as the forming method and material properties of the external electrodes 160, rather than elaborating on it.

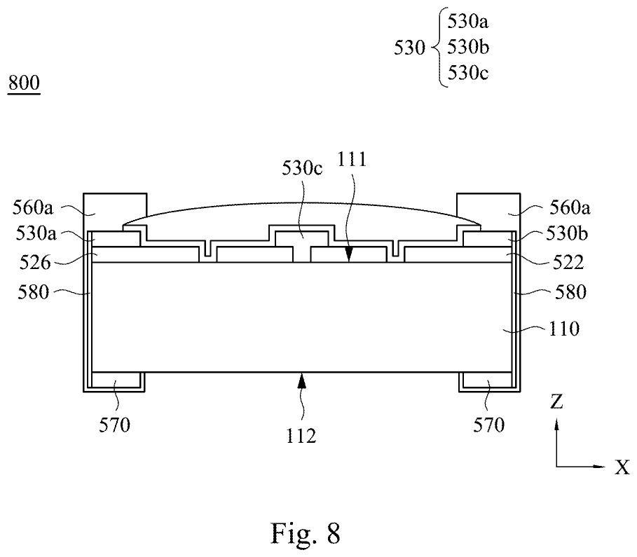

Reference is made to FIG. 8. FIG. 8 depicts a cross-sectional view of a thermal resistor 800 according to yet another embodiment of the present disclosure. The differences between the thermal resistor 800 of FIG. 8 and the thermal resistor 500 of FIG. 7 are that the thermal resistor 800 further includes external electrodes 560a, back electrodes 570, and side electrodes 580. Similar to the structure of FIG. 4, the pair of back electrodes 570 of the thermal resistor 800 of FIG. 8 is first formed on the second surface 112 of the substrate 110, and then the pair of side electrodes 580 is respectively formed on opposite sidewalls of the substrate 110. Next, the external electrodes 560a is formed to cover the pair of back electrodes 570 and the pair of side electrodes 580.

In summary, each of the thermistors in the thermal resistor of the present disclosure is made of a base metal, such as pure nickel, pure titanium, or the titanium-tungsten alloy, etc. There is no necessity to use any noble metal, such as platinum, etc., so the production cost can be reduced. The thermistor(s) of the present disclosure have a higher temperature coefficient of resistance (TCR), which can provide a more sensitive and precise temperature response. In addition to that, the process of the thermistor(s) of the present disclosure is similar to that of the thin film resistor, so the thermistor(s) can be produced quickly and in mass production.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A thermal resistor comprising:
a substrate;
a first thermistor disposed on a first surface of the substrate, and the first thermistor not comprising an oxide, wherein the first thermistor has a first trimming groove;
a first front electrode and a second front electrode respectively disposed on two sides of the first thermistor, and contacting the first thermistor;
a passivation protection layer conformally covering the first thermistor, wherein a thickness of the passivation protection layer is from 0.01 μm to 1 μm; and
an external protection layer covering the passivation protection layer.

2. The thermal resistor of claim 1, wherein a temperature coefficient of resistance of the first thermistor is greater than 4000 ppm/° C.

3. The thermal resistor of claim 1, wherein the passivation protection layer covers the first front electrode with a width not greater than ⅓ of an entire width of the first front electrode.

4. The thermal resistor of claim 1, wherein the passivation protection layer covers the second front electrode with a width not greater than ⅓ of an entire width of the second front electrode.

5. The thermal resistor of claim 1, wherein a material of the first thermistor is pure nickel, pure titanium, or a titanium-tungsten alloy.

6. The thermal resistor of claim 1, further comprising:
a pair of external electrodes respectively disposed on the first front electrode and the second front electrode, and respectively covering one sidewall of the first front electrode and one sidewall of the second front electrode, and respectively covering opposite sidewalls of the first thermistor.

7. The thermal resistor of claim 6, further comprising:
a pair of back electrodes disposed on a second surface opposite to the first surface of the substrate, wherein the pair of external electrodes further respectively cover opposite sidewalls of the substrate and the pair of back electrodes.

8. The thermal resistor of claim 1, further comprising:
a second thermistor disposed on the first surface of the substrate, wherein the first thermistor is spaced apart from the second thermistor, the second front electrode contacts the substrate and the second thermistor, wherein the second thermistor does not comprise an oxide, and the second thermistor has a second trimming groove; and
a third front electrode disposed on one side of the second thermistor and contacting the second thermistor, wherein the passivation protection layer further conformally covers the second thermistor, and the external protection layer covers the second front electrode and the passivation protection layer.

9. The thermal resistor of claim 8, wherein a material of the first thermistor is pure nickel, pure titanium, or a titanium-tungsten alloy, and a material of the second thermistor is pure nickel, pure titanium, or a titanium-tungsten alloy.

10. The thermal resistor of claim 8, further comprising:
a pair of external electrodes respectively disposed on the first front electrode and the third front electrode, and respectively covering one sidewall of the first front electrode and one sidewall of the third front electrode, and respectively covering opposite sidewalls of the first thermistor.

11. The thermal resistor of claim 10, further comprising:
a pair of back electrodes disposed on a second surface opposite to the first surface of the substrate, wherein the pair of external electrodes further respectively cover opposite sidewalls of the substrate and the pair of back electrodes.

12. A manufacturing method of a thermal resistor, comprising:
forming a thermistor layer on a first surface of a substrate;
forming an electrode layer on the thermistor layer, wherein the electrode layer covers at least a portion of the thermistor layer;
performing a trimming operation;
conformally forming a passivation protection layer on the thermistor layer, wherein the passivation protection layer completely covers the thermistor layer;
forming an external protection layer to cover the passivation protection layer and a portion of the electrode layer; and
forming a pair of external electrodes by electroplating, wherein the pair of external electrodes cover a remaining portion of the electrode layer.

13. The manufacturing method of the thermal resistor of claim 12, further comprising:
forming a pair of back electrodes on a second surface opposite to the first surface of the substrate; and
respectively forming a pair of side electrodes on opposite sidewalls of the substrate, wherein the pair of external electrodes cover the pair of back electrodes and the pair of side electrodes.

14. The manufacturing method of the thermal resistor of claim 12, wherein the operation of forming the thermistor layer comprises:
forming a first thermistor and a second thermistor, wherein the first thermistor is spaced apart from the second thermistor;
wherein the operation of forming the electrode layer on the thermistor layer comprises:
forming a first front electrode on one side of the first thermistor and contacting the first thermistor;
forming a second front electrode on one side of the second thermistor and contacting the second thermistor; and
forming a third front electrode to cover another side of the first thermistor and another side of the second thermistor, wherein the third front electrode contacts the substrate.

15. The manufacturing method of the thermal resistor of claim 14, wherein the operation of performing the trimming operation further comprises:
performing a first trimming process on the first thermistor by using an etching method to form a first trimming groove; and
performing a second trimming process on the second thermistor by using a laser method to form a second trimming groove.
